(19) United States
(12) Patent Application Publication
(10) Pub. No.: US 2026/0177104 A1
(43) Pub. Date: Jun. 25, 2026

(54) METHOD OF MANUFACTURING A ROLLING OR PLAIN BEARING RING

(71) Applicant: AKTIEBOLAGET SKF, GOTEBORG (SE)

(72) Inventors: Marcus C. ANDERSSON, Mölndal (SE); Marcel ESCURSELL TREPAT, Göteborg (SE)

(21) Appl. No.: 19/416,229

(22) Filed: Dec. 11, 2025

(30) Foreign Application Priority Data
Dec. 19, 2024 (DE) 102024138993.1

(51) Int. Cl. F16C 33/12; B22F 10/25; B33Y 10/00; B33Y 70/00; B33Y 80/00; F16C 33/14

(52) U.S. Cl. CPC F16C 33/125; B22F 10/25; F16C 33/14; B33Y 10/00; B33Y 70/00; B33Y 80/00

(57) ABSTRACT

A method of manufacturing a rolling or plain bearing ring includes forming a metallic ring member by depositing metal by use of a Directed Energy Deposition (DED) operation. A load carrying surface is applied onto the formed metallic ring member by use of a further or additional DED operation.

### CROSS-REFERENCE

This application claims priority to German patent application no. 102024138993.1 filed on Dec. 19, 2024, the contents of which are fully incorporated herein by reference.

### BACKGROUND OF THE INVENTION

The present invention relates to bearings, and more particularly to a method for manufacturing a rolling or plain bearing ring and a rolling or plain bearing ring made according to the method.

Rolling bearings and plain bearings are well-known mechanical components used for carrying loads while allowing a relative rotation between their bearing rings. The rolling bearing carries loads via rolling elements, such as balls and rollers, while the plain bearing, also referred to as a “sliding bearing”, carries loads by means of sliding surfaces.

A bearing ring is generally manufactured from a piece of rolled/forged steel substrate by e.g., surface cutting, grinding, and honing until a final bearing ring component is provided. The bearing ring is also commonly subjected to a heat treatment process in order to increase its surface hardness and thereby achieve a high fatigue resistance of especially the ring's load carrying surfaces. Thereby, a long service life of the bearing ring can be achieved.

It is also known to provide bearing rings which are made of more expensive materials for providing increased performance. For example, a bearing ring may be made of stainless steel, thereby providing a corrosion resistant ring. However, due to the relatively high cost of stainless steel, larger bearings—such as bearings having an outer diameter of more than 500 mm (millimeter)—may be very expensive to produce due to the high material cost or not even possible to produce due to limitations in reduction ratio.

Instead of using an expensive material such as stainless steel, a bearing ring may be made of a less expensive material and may be coated with a high performance material for providing additional characteristics like corrosion resistance, etc. Thus, in this case, the base ring is manufactured in a traditional manner using hot forming processes like forging and/or rolling and is then coated. However, when large size bearings are produced, the volumes are normally very limited, which results in high cost and long lead times for such bearing rings.

The lead time for sourcing components to large size bearings, for example bearing rings, are often 8-12 months. The cost associated with this type of sourcing is also very high, as the volumes are very low and high quality steel in large tonnages are needed. Furthermore, if something goes wrong in production, a new order (again 8-12 months) needs to be placed. This may be overcome by building up a stock of these bearings, which may result in high costs without certainty as to whether the stocked items will actually be needed.

### SUMMARY OF THE INVENTION

It is therefore object of the present invention to provide a bearing ring in a cost-efficient and faster way compared with the above-mentioned manufacturing methods.

This object is solved by a method for manufacturing a rolling or plain bearing ring, comprising:
forming a metallic ring member by depositing metal by use of a Directed Energy Deposition (“DED”) operation; and
applying a load carrying surface onto the formed metallic ring member by use of a further DED operation.

Based on this method, a bearing ring may be easily and fast manufactured simply based on a DED operation. DED as used herein is intended to mean a kind of 3D printing of the bearing ring. Thus, in a first step, the metallic ring member is formed or 3d printed using DED. The metal may be deposited on a carrier material which may be subsequentially removed. Alternatively, the carrier material may be part of the bearing ring and may remain on the bearing ring. The carrier material may be for example a thin metal film of the same material as the material of the metallic ring member.

In the second step, the load carrying surface is applied onto the ring member also using DED. Here, DED is used for coating the formed ring member.

DED is a surface welding operation which enables a metallurgical bonding of material of the load carrying surface to the metallic ring member (and/or of the material of the ring member to the carrier material) thereby providing a DED bonded surface on the metallic ring member (and/or on the carrier material). Other examples of DED, in addition to laser cladding, are plasma transferred arc (PTA), electron beam melting (EBM) and selected laser melting (SLM).

DED processes may deposit materials at very high deposition rates (up to 10 kg per hour). Thus, a bearing ring may be manufactured in a short time compared to previous methods and may be manufactured, for example, on demand based on user/costumer requests. Further, DED processes provide a manufactured product with dimensional stability which leads to small tolerances for post machining, and thus to reduced post machining, further improving the manufacturing with respect to required time and costs. For example, using 3D printing, in particular DED, for sourcing bearing rings, the lead time can be reduced to 3-4 weeks compared to the previously needed 8-12 weeks.

Further, the present manufacturing method may provide the advantage that bearing rings of different types and sizes may be easily manufactured using the same starting product, i.e., material. The present manufacturing method may thus be adapted to different bearing types and sizes based on user or customer requests.

The DED operation for forming the metallic ring member and/or applying the load carrying surface may be a steel wire and/or steel metal powder DED operation. In particular, it has been realized that by a wire and/or powder based DED operation, a steel surface can be applied on the metallic ring member consisting of an arbitrary metal, for example a low cost metal, wherein the metal surface is preferably a high performing steel surface. Thereby, a rolling or plain bearing ring with an increased service life is achieved in a cost-effective and time-efficient manner. Furthermore, by using DED, a layer of the steel material having any desired thickness can be applied on the metallic ring member, implying further improved performance.

Further, the material of the load carrying surface may be selected according to specific applications, such as for pulp and paper applications, wind turbines, metal, and mining industry applications, etc. This provides increased flexibility due to the adaptability of the specific material of the load carrying surface based on the respective application. A load carrying surface herein refers to a surface which is intended to be subjected to loads, typically alternating loads, during use. Preferably, the load carrying surface is a raceway surface of the rolling or plain bearing ring. However, the load carrying surface may also be, for example, an inner circumferential surface of an inner bearing ring and/or an outer circumferential surface of an outer bearing ring. Furthermore, the load carrying surface may be any surface of the rolling or plain bearing ring which is intended to carry a load with a main force component which is directed substantially straight toward the surface.

In addition, when using a steel wire and/or steel metal powder DED operation, the only stock material required is one or more containers (e.g., barrels) of wire/powder for the printing process. This stock may be much smaller compared to previous manufacturing methods because the same type of stock may be used for all bearing types and sizes.

The steel wire and/or steel metal power for the metallic ring member may comprise a low strength steel, in particular S355J2, 42CrMo4, 21CrMoV5-11, 16CrMo4, and/or 25CrMo4.

Thus, the metallic ring member may be cost-efficiently produced using low-cost materials, like construction steel such as S355J2, 42CrMo4, low alloyed low carbon steel materials, etc. The ring member may thus be formed using a comparatively inexpensive material, whereas the required strength and other characteristics of the bearing ring may be provided by the load carrying surface deposited on the metallic ring member. For example, a less expensive material may be used for the metallic ring member, such as a standard steel which is not stainless, e.g., a steel having a chromium (Cr) content below 10 wt %.

The steel wire and/or steel metal powder for the load carrying surface may comprise Carbon (C) and Boron (B) as hardening mechanisms. It has been realized that DED, e.g., laser cladding, of a steel wire and/or steel metal powder which only comprises C as a hardening mechanism may not provide a surface with a sufficient surface hardness without a high risk of cracking. More specifically, it has been found that a raceway surface which has been coated with a steel wire and/or steel metal powder which only comprises C as hardening mechanism may not provide sufficient surface hardness, especially for more demanding applications, without a high risk of cracking in the raceway surface. Thereby, by also providing B as hardening mechanism, it has been discovered that a high surface hardness of the load carrying surface can be achieved which is suitable for more demanding applications, while also reducing the risk of cracking. For example, it has been found that a load carrying surface with a surface hardness of at least 55 HRC can be achieved, such as 55-58 HRC, when the steel metal powder and/or steel wire comprises C and B as hardening mechanisms. Still optionally, the steel wire and/or steel metal powder may comprise 0.10-0.50 wt (weight) % of C and 0.50-1.50 wt % of B. For example, it has been found that a higher surface hardness can be achieved by using the aforementioned amounts of C and B, typically by using a higher amount of B compared to the amount of C in e.g., the steel metal powder. According to an example embodiment, the total wt % of C and B is in the range of 0.6-1.7 wt %, such as substantially 0.2 wt % C and 0.9 wt % B.

Optionally, the steel wire and/or steel metal powder may be a stainless steel wire and/or a stainless steel metal powder, respectively. Thereby, a corrosion resistant surface can be provided by the DED operation, which is a high-performance surface compared to, for example, the low cost material of the previously formed ring member.

Applying the load carrying surface may comprise applying more than one layer by use of DED, such as 2-20 layers. Providing more than one layer, such as 2-20 layers, has been shown to result in a high-performance surface with a satisfactory thickness for more demanding applications. The increased number of layers may also reduce the amount of heat transferred to the previously formed metallic ring member, implying a reduced risk of cracking in the metallic ring member.

Depositing metal by use of a Directed Energy Deposition (DED) operation for forming the metallic ring member comprises depositing a plurality of layers by use of DED. The plurality of layers may be, for example, hundreds of layers.

Thus, the metallic ring member may be built by depositing one layer after the other, until a desired thickness of the metallic ring member is reached. This means that any desired thickness of the metallic ring member, and thus of the bearing ring, may be achieved by adjusting the number of layers.

Further, the ratio between the metallic ring member and the applied load carrying surface, as seen in a radial direction of the rolling or plain bearing ring, may be variable. By selecting a specific ratio, the characteristic of the bearing ring may be further adapted. For example, the load carrying capacity may be enhanced or reduced by having a higher or lower percentage of the load carrying surface within the overall ratio. The same applies to the cost of the bearing ring, i.e., by having a higher or lower percentage of the cost-efficient material of the ring member, the overall cost of the bearing ring may be increased or reduced.

Optionally, the speed of applying the load carrying surface by DED, i.e., the DED speed, such as laser cladding speed, may be in the range of 0.5 to 1000 m (meter) per minute. According to an example embodiment, the DED speed is greater than 1 m per minute, such as greater than 20 m per minute, e.g., 80-120 m/minute, implying a reduced cracking risk of the metallic ring member. It has namely been found that a higher DED speed, such as laser cladding speed, may reduce the risk of cracking. Thereby, by e.g., using a greater laser cladding speed, an improved rolling or plain bearing ring may be provided.

Optionally, when the DED operation is laser cladding, the laser power used when applying the load carrying surface may be 1-30 kW (kilowatts), in particular 5-16 kW.

Optionally, the application speed may be varied during application of the steel wire material and/or steel metal powder on the carrier material and/or the metallic ring member. Thereby, one or more layers with different radial thickness may be applied. For example, the carrier material and/or the metallic ring member may be rotated with respect to a rotational axis of the metallic ring member while applying the load carrying surface, wherein the rotational speed is varied during application of the steel wire and/or steel metal powder on the carrier material and/or metallic ring member. By varying the speed, less heat may be transferred to the carrier material and/or the metallic ring member, as well as subsequent layers of the metallic ring member and/or the load carrying surface, during the DED operation.

According to an example embodiment, the speed is varied by decreasing the speed at least one time during the application of the layers of the metallic ring member and/or load carrying surface. Thereby a relatively high speed can be used, for example when applying a first layer directly onto the metallic ring member, whereby a relatively low speed can be used when applying one or more additional layers on the first layer. The same applies for the layers of the metallic ring member. Consequently, the first layer will be thinner than the one or more additional layers. This may result in that less heat will be transferred to the metallic ring member, thereby reducing the risk of generating cracks therein during the DED, e.g. the laser cladding, operation.

Furthermore, by varying the application speed, a surface with a varying radius may be provided with a load carrying surface with a substantially uniform thickness. For example, the rolling or plain bearing ring may have a spherical surface with a varying radius, whereby the application speed is varied such that a load carrying surface with a substantially uniform thickness is provided thereon. Accordingly, the application speed may be varied such that a constant surface speed is achieved during the DED operation. The same applies for the forming of the metallic ring member. Optionally, the final thickness of the applied load carrying surface may be 0.25-10 m, as seen in a radial direction of the rolling or plain bearing ring.

According to a further aspect, a rolling or plain bearing ring for a rolling or plain bearing is provided, wherein the rolling or plain bearing ring has been manufactured by the method according to any one of the embodiments of the method as described above.

The rolling bearing ring may be a ring of any kind of rolling bearing. For example, it may be a ball bearing or roller bearing, including but not limited to a spherical roller bearing, a tapered roller bearing, a toroidal roller bearing, a cylindrical roller bearing, a spherical ball bearing, a deep groove ball bearing and an angular contact ball bearing. The plain bearing ring may be a ring of any kind of plain bearing, such as a spherical plain bearing.

According to a further aspect, a rolling or plain bearing is provided which comprises at least one rolling or plain bearing ring as described above.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE SEVERAL VIEWS OF THE DRAWINGS

In the following, preferred embodiments of the invention are described in relation to the drawings, wherein the drawings are exemplary only, and are not intended to limit the scope of protection. The scope of protection is defined by the accompanied claims, only. The figures show:

FIG. 1 is a cross-sectional view of a rolling or plain bearing ring;

FIG. 2 is a schematic side view of a rolling bearing comprising the ring of FIG. 1;

FIG. 3 is a cross-sectional view of the rolling or plain bearing ring of FIG. 1; and

FIG. 4 is a flowchart of a method for manufacturing a rolling or plain bearing ring according to FIG. 1-3.

### DETAILED DESCRIPTION OF THE INVENTION

In the following same or similar functioning elements are indicated with the same reference numerals.

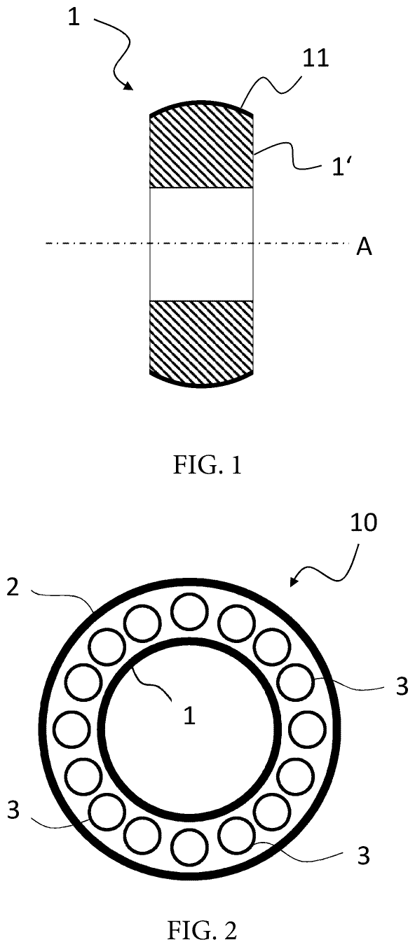

FIG. 1 shows a cross-sectional view of a rolling or plain bearing ring 1 which may be used in a rolling or plain bearing. The cross-sectional view is defined by a plane which extends along a rotational axis A of the rolling or plain bearing ring 1. The rolling or plain bearing ring 1 comprises a metallic ring member 1′. It further comprises a load carrying surface 11 provided on the metallic ring member 1′.

For providing a time and cost efficient way of manufacturing the bearing ring 1, the metallic ring member 1′ as well as the load carrying surface 11 are formed by a DED operation.

Thus, first the metallic ring member 1′ is formed by applying layers of the metal material of the metallic ring member 1′ onto a carrier material (not shown) which may either remain on the bearing ring 1 or may be removed from the bearing ring 1 after forming the metallic ring member 1′ and/or the load carrying surface 11. After that, the load carrying surface 11 is applied onto the metallic ring member 1′ by an additional DED operation (i.e., additional to the initial DED operation forming the ring member 1′).

The load carrying surface 11 is preferably a raceway surface, such as a raceway surface for rolling elements, i.e., balls and/or rollers. As shown, the raceway surface 11 may have a spherical shape. Thereby, the rolling or plain bearing ring 1 is capable of being misaligned relative an outer ring 2 (see FIG. 2). As a result, a rolling or plain bearing 10, such as the rolling bearing shown in FIG. 2, which comprises the rolling or plain bearing ring 1, may be able to accommodate shaft deflections during use. Other forms of bearing rings 1 may also be formed.

FIG. 2 shows a side view of a rolling bearing 10 which comprises the rolling bearing ring 1 as e.g., shown in FIG. 1. The rolling bearing ring 1 is shown as an inner ring of the rolling bearing 10. The rolling bearing 10 further comprises the above-mentioned outer ring 2 and a plurality of rolling elements 3 disposed between the outer ring 2 and the rolling bearing ring 1. It should be noted that the outer ring 2 may alternatively or additionally be provided with a load carrying surface 11 as described above.

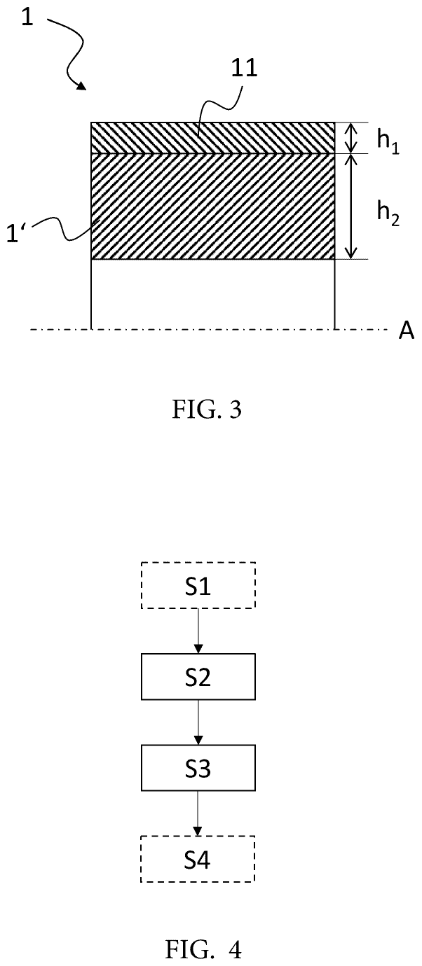

FIG. 3 shows a cross-sectional view of a portion of the rolling or plain bearing ring 1 according to FIG. 1. As already mentioned, it comprises the load carrying surface 11 and the metallic ring member 1′, both being formed using DED. The load carrying surface 11 has a radial thickness h₁, which may be, for example, 0.25-10 mm. The radial direction of the ring 1 is perpendicular to and intersects the rotational axis A of the rolling or plain bearing ring 1. The metallic ring member 1′ has a radial thickness h₂ which is substantially greater than the radial thickness h₁, such as 10-500 mm. The two thicknesses h₁, h₂ may be adjusted depending on the intended application of the bearing ring 1. For example, for applications with higher loads, the thickness h₁ of the load carrying surface 11 may be increased, whereas for applications with lower loads, the thickness h₁ of the load carrying surface 11 may be reduced with respect to the thickness h₂ of the metallic ring member 1′.

Further, it should be noted that the metallic ring member 1′ as well as the load carrying surface 11 may consist of a plurality of single or individual layers which are applied on top of each other using a DED operation.

In FIG. 4, a flowchart of a method for manufacturing the bearing ring 1 of FIGS. 1 to 3 is illustrated.

In a first step S1, a carrier material is provided on which the metallic ring member 1′ may be formed. This step S1 is optional, and it should be noted that other ways of forming the metallic ring member 1′ are possible, such as by using a mold or the like.

In a second step S2, the layers of the metallic ring member 1′ are applied or deposited using a DED operation. During this DED operation, for example laser cladding, steel wire and/or steel metal power is fused layer by layer to form the metallic ring member 1′. This step S2 may be carried out until a desired thickness h₂ of the metallic ring member 1′ is reached.

In a third step S3, the load carrying surface 11 is applied onto the metallic ring member 1′ also by use of a DED operation. This DED operation may be done using the same machine or apparatus as in step S2, wherein only the used steel wire and/or steel metal powder needs to be exchanged for providing different features or characteristics to the load carrying surface 11 and the metallic ring member 1′. Thus, only one production site is needed for steps S2 and S3.

It should be noted that the layers of the metallic ring member 1′ and the layers of the load carrying surface 11 may also comprise or include different materials. For example, the layers of the metallic ring member 1′ may consist of alternating layers of two or more materials, such as different kinds of steel. The same applies to the load carrying surface 11. This may provide the advantage that additional features, properties, and/or characteristics may be added to the metallic ring member 1′ and/or the load carrying surface 11.

After a desired thickness h₁ of the load carrying surface 11 has been reached, the method may end or may continue with step S4, in which the carrier material of step S1 can be removed. It should be noted that, in case a carrier material is used, this carrier material may also be removed after step S2 and before step S3.

In summary, the herein described manufacturing method and corresponding bearing ring provides a flexible approach of manufacturing a bearing ring 1 with respect to type and size of the bearing ring. For example, the thickness and materials of the layers may be adapted according to specific requirements of the intended application. Further, the bearing ring 1 may be easily manufactured using the same manufacturing apparatus by simply exchanging the added wire/powder.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### REFERENCE NUMERALS

1 rolling or plain bearing ring
1 metallic ring member
2 outer ring
3 rolling elements
10 rolling bearing
11 load carrying surface
A rotational axis
h₁ thickness of load carrying surface
h₂ thickness of metallic ring member
S1-S4 method steps

We claim:

1. A method of manufacturing a rolling or plain bearing ring, the method comprising the steps of:
forming a metallic ring member by depositing metal by use of a Directed Energy Deposition (DED) operation; and
applying a load carrying surface onto the formed metallic ring member by use of an additional DED operation.

2. The method according to claim 1, wherein the DED operation for forming the metallic ring member and/or applying the load carrying surface is a steel wire DED operation and/or a steel metal powder DED operation.

3. The method according to claim 2, wherein the steel wire and/or the steel metal power for the metallic ring member is a low strength steel.

4. The method according to claim 3, wherein the steel wire and/or the steel metal powder is S355J2 and/or 42CrMo4.

5. The method according to claim 2, wherein the steel wire and/or the steel metal powder for the load carrying surface includes carbon and boron as hardening mechanisms.

6. The method according to claim 5, wherein the steel wire and/or the steel metal powder for the load carrying surface includes 0.10-0.50 wt % of carbon and 0.50-1.20 wt % of boron.

7. The method according to claim 2, wherein the steel wire for the load carrying surface is a stainless steel wire and/or the steel metal powder for the load carrying surface is a stainless steel metal powder.

8. The method according to claim 1, wherein the step of applying the load carrying surface includes applying more than one layer by use of DED.

9. The method according to claim 8, wherein the step of applying the load carrying surface includes applying 2-20 layers by use of DED.

10. The method according to claim 1, wherein the step of depositing metal by use of a Directed Energy Deposition (DED) operation for forming the metallic ring member includes depositing a plurality of layers by use of DED.

11. The method according to claim 1, wherein a ratio of a radial thickness of the metallic ring member and a radial thickness of the applied load carrying surface is variable.

12. A rolling or plain bearing ring for a rolling or plain bearing, wherein the rolling or plain bearing ring has been manufactured by the method according to claim 1.
